(19) United States
(12) Patent Application Publication
(10) Pub. No.: US 2012/0308139 A1
(43) Pub. Date: Dec. 6, 2012

(54) METHOD AND SYSTEM FOR FACILITATING SUBSCRIBER SERVICES USING MOBILE IMAGING

(75) Inventor: Dinesh Dhir, Plano, TX (US)

(73) Assignee: VERIZON PATENT AND LICENSING INC., Basking Ridge, NJ (US)

(21) Appl. No.: 13/149,695

(22) Filed: May 31, 2011

(51) Int. Cl. G06K 9/20

(52) U.S. Cl. 382/190

(57) ABSTRACT

An approach for providing access to subscriber services. A service processing platform receives a request and associated one or more images and determines an application associated with the request. The service processing platform also extracts data from the one or more images according to the determined application and forwards the extracted data to one or more subscriber systems for processing based on a subscriber service. The one or more subscriber systems are registered with the service processing platform.

### BACKGROUND INFORMATION

Service providers are continually challenged to develop new and innovative services to remain competitive. Consumer adoption of mobile devices, such as cellular telephones, laptop computers, personal digital assistants, and the like, is increasing. More so, is the integration of mobile devices and image capturing systems. Mobile devices are often outfitted with an image capturing system, such as a camera. For example, many consumers now own a mobile phone that can be used to take photos and quickly share the images with family and acquaintances who are in distance places. Such mobile technology has enabled users to access rich media services over a data communications infrastructure, such as the Internet. However, little effort has been expended to integrate mobile technology infused with image capturing systems with business processes.

Therefore, there is a need to enhance business processes with mobile imaging technology as to provide greater convenience for users to engage in those processes.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system configured to provide subscriber services to users of user devices, according to one embodiment;

FIG. 2 is and a flowchart of a process for providing subscriber services to users of user devices, according to one embodiment;

FIG. 3 is a diagram of a service processing platform capable of providing subscriber services, according to one embodiment;

FIG. 4 is a diagram demonstrating extraction of data from an image by multiple applications, according to one embodiment;

FIG. 5 is a diagram of a system capable of providing subscriber services, according to one embodiment;

FIG. 6 is a flowchart of a process for obtaining pricing information of insurance services, according to one embodiment;

FIG. 7 is a flowchart of a process for obtaining a policy update, according to one embodiment;

FIG. 8 is a diagram of a mobile device capable of providing a graphical user interface (GUI) configured to present policy management options and active policies, according to one embodiment;

FIG. 9 is a flowchart of a process for requesting processing of a claim according to one embodiment;

FIG. 10 is a flowchart of a process for obtaining status update on the processing of a claim, according to one embodiment;

FIG. 11 is a diagram of a computer system that can be used to implement various exemplary embodiments; and

FIG. 12 is a diagram of a chip set that can be used to implement various exemplary embodiments.

### DESCRIPTION OF THE PREFERRED EMBODIMENT

A preferred apparatus, method, and software for facilitating subscriber services using mobile imaging are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to mobile devices with built-in imaging capability, it is contemplated that various exemplary embodiments are also applicable to stationary devices and imaging capability that is externally coupled to the devices.

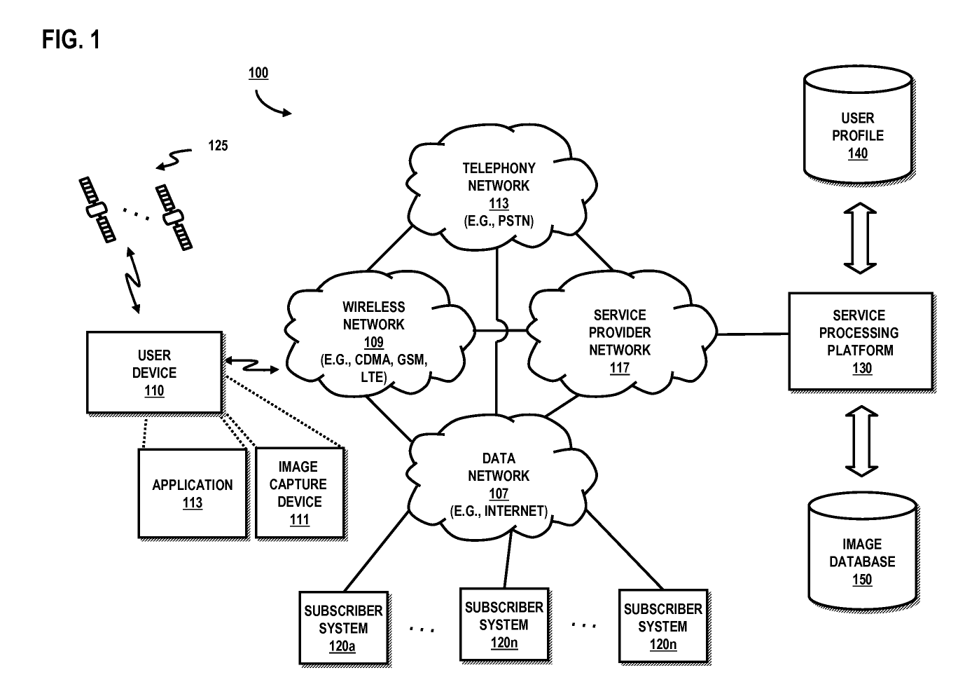

FIG. 1 is a diagram of a system configured to provide subscriber services to users of user devices, according to one embodiment. For the purpose of illustration, system 100 includes a service processing platform 130, which facilitates submission of images from users devices (of which one is shown) 110 to the platform 130 for processing by various subscriber systems 120a-120n. These systems 120a-120n correspond to variety of vendors or other service providers; alternatively, the systems 120a-120n, in whole or in part, be associated with a single vendor (e.g., corresponding to different departments of a large organization). By way of example, service processing platform 130 is implemented as a managed service, whereby these other vendors or other service providers are considered “subscribers” to the services of platform 130. Mobile or portable device users, who enjoy an increased level of mobility, still have to sacrifice a great deal of time and effort to communicate with agents of various service providers. For example, consumers working with insurance agents often have to provide various documents and personal data relating to their policies and circumstances/evidence to support insurance claims. Traditionally, within the realm of insurance services, an agent typically communicates with a customer (i.e., customer of a vendor service) via telephone or a website. For both the agent and the customer, supplying information from the customer to the agent often requires cumbersome steps and engaging in a variety of communication means, resulting in loss of time and money. This is particularly challenging when the customer has to provide the agent with detailed information, such as policy numbers and identification information.

Therefore, the approach of system 100, according to certain exemplary embodiments, stems from the recognition that consumers and service providers can benefit from the convenience of conducting commerce (e.g., service processing) through mobile imaging. For example, an insurance service provider may require that vehicle identification numbers (VINs), driver's license information, and insurance policy numbers be required before claims are submitted for processing. With platform 130, the user need merely invoke an application 113 to submit digital images of documents that contain such information. In effect, with the ubiquity of user devices 110 being equipped with image capture devices 111, the images can be readily transferred using application 113 to service processing platform 130. Platform 130 can then extract the required data (e.g., textual data) from the images and relay the extracted data to the appropriate subscriber system 120a. It is contemplated that the extraction process can be performed in a manner that is customized for the particular application—e.g., subscriber system 120a. In one embodiment, service providers of systems 120a-120n may access the platform 130 to supply predetermined data types necessary for implementing various provided services; these data types are employed in the data extraction process.

According to certain embodiments, users of one or more user devices 110 (e.g., mobile device, computing device) may access the features and functionalities of platform 130 over one or more networks, such as data network 107, wireless network 109, telephony network 113, and/or service provider network 117, in order to receive services provided by subscriber systems 120. It is noted that user device 110 may possess computing functionality as to support messaging services (e.g., short message service (SMS)), and thus, can partake in the services of platform 130. While specific reference will be made hereto, it is contemplated that system 100 may embody many forms and include multiple and/or alternative components and facilities.

By way of example, user devices 110 (e.g., laptops, netbooks, cellular phones, smart phones, etc.) may be configured to capture images by utilizing an image capture device 111 (e.g., camera). Under this scenario, images are captured with device 111, and forwarded over the one or more networks 107, 109, 113, and 117 via an application 113. For example, the user devices 110 may be configured to forward the captured images over one or more networks via various messages (e.g., SMS, e-mail), which may be initiated and transmitted to predetermined end-points as specified by the user, such as subscriber systems 120.

As shown in the example of FIG. 1, a constellation of global positioning system (GPS) satellites 125 can communicate with the mobile devices 110 to provide location of the devices 110. By way of example, one or more mobile devices 110 may be configured to determine corresponding spatial positioning information through conventional satellite positioning system (SPS) technology, such as GPS technology; however, any suitable navigational or location determination technology may be utilized, such as advanced forward link trilateration (A-FLT), assisted-GPS (A-GPS), enhanced cellular identification (CELL-ID), wireless area network (WLAN) positioning, etc. SPS technology utilizes a constellation of satellites that transmit signals to receivers (not shown) of, for example, one or more mobile devices 110, so that the receivers may determine corresponding spatial positions (or locations), speeds, directions, and/or timing for mobile devices 110.

In certain embodiments, user devices 110 may include cellular phones, BLUETOOTH-enabled devices, WiFi-enable devices, radiophone, satellite phone, smart phone, wireless phone, or any other suitable mobile device, such as a personal digital assistant (PDA), pocket personal computer, tablet, customized hardware, etc. In addition, user devices 110 may include a computer (not shown) (e.g., desktop computer, laptop, web appliance, etc.), and voice station (e.g., conventional telephone). By way of example, the computing device may be any suitable computing device capable of running the application 113; moreover, the computing device can be a voice over internet protocol (VoIP) phone, skinny client control protocol (SCCP) phone, session initiation protocol (SIP) phone, IP phone, personal computer, softphone, workstation, terminal, server, etc.

For the purpose of illustration, user devices 110 may be any device capable communicating over a wireless network 109 using voice sessions as well as other non-voice sessions, e.g., short messaging service (SMS), enhanced messaging service (EMS), multimedia messaging service (MMS), instant messaging (IM), etc.

In system 100, according to certain embodiments, one or more networks, such as data network 107, service provider network 117, telephony network 113, and/or wireless network 109, are provided to handle various communication sessions, voice communications as well as non-voice communications. Networks 107-117 may be any suitable wireline and/or wireless network. For example, telephony network 113 may include a circuit-switched network, such as the public switched telephone network (PSTN), an integrated services digital network (ISDN), a private branch exchange (PBX), or other like network.

Wireless network 109 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Meanwhile, data network 107 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107, 109, 113, and 117 may be completely or partially contained within one another, or may embody one or more of the aforementioned infrastructures. For instance, service provider network 117 may embody circuit-switched and/or packet-switched networks that include facilities to provide for transport of circuit-switched and/or packet-based communications. It is further contemplated that networks 107, 109, 113, and 117 may include components and facilities to provide for signaling and/or bearer communications between the various components or facilities of system 100. In this manner, networks 107, 109, 113, and 117 may embody or include portions of a signaling system 7 (SS7) network, or other suitable infrastructure to support control and signaling functions.

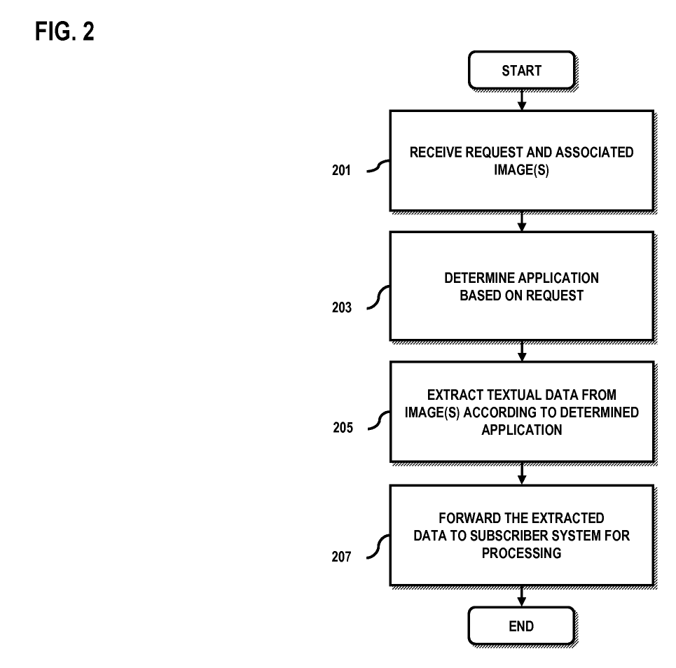

FIG. 2 is a flowchart of a process for providing subscriber services to a user of user device 110. In step 201, service processing platform 130 receives a request for a service provided by one or more of the subscriber systems 120 from the user device 110. By way of example, the request may be for a price quote to obtain an insurance policy, which can be provided by any one of the various subscriber systems 120a-120n. That is, under this scenario, the subscriber systems 120a-120n are operated by different insurance carriers. In one embodiment, along with the request, the service processing platform 130 receives one or more images associated with the request. The images may be of any relevant document to obtain the pricing information; the images may include a driver's license or passport as well as an image the vehicle's vehicle identification number (VIN). The service processing platform 130 may receive the request and associated images via various forms and formats; e.g., text message, email, etc.

In step 203, the service processing platform 130 determines an application associated with the request. The service processing platform 130 determines what application should be invoked based on the request from the user of the user device 110. In accordance with certain embodiments, the service processing platform 130 may generally determine that the user of the user device 110 is requesting an insurance service. More particular, and as example, the service processing platform 130 may determine that the user is requesting pricing information for the insurance service, updating an existing, and/or processing of an insurance claim. That is, platform 130 can determine from the request (as generated by application 113) the exact service the user is seeking; e.g., obtaining a rate quote.

In determining an application associated with the request, the service processing platform 130 may also verify that the quality of the one or more images that may be included with the request are of sufficient image quality for use by the service processing platform 130, as well as the subscriber systems 120. If the service processing platform detects that the images are not of sufficient quality, the platform 130 may take measures to obtain sufficient quality images. In certain embodiments, the platform 130 may request the application 113 within the device 110 to provide additional images; the user may be prompted by the application 113 on how to take a satisfactory picture. Alternatively or additionally, the application 113 can be requested by the platform 130 to configure the image capture device 111 (e.g., by changing the camera settings) to provide a higher quality picture. In other embodiments, the platform 130 may itself attempt corrective measures by enhancing the received images received from the user device 110.

In step 205, the service processing platform 130 extracts textual data from the images received from the user device 110. The extraction of text can be performed by any tool capable of recognizing characters embedded in an image and translating the characters into an electronic file—e.g., optical character recognition (OCR) mechanism. In some embodiments, the service processing platform 130 recognizes and extracts predetermined text. The predetermined text can be any text and/or information that has been determined as being relevant and/or critical for properly providing one or more service for the particular subscriber system. This information may be derived from a driver's license—e.g., address information, account number, and/or a social security number. Under this approach, mobile imaging technology is leveraged to conveniently extract data from certain images.

In certain embodiments, the service processing platform 130 extracts textual data from the images according to a determined application. For example, if the service processing platform 130 determines an application for obtaining pricing information (e.g., quote) for an insurance service is requested by a user of a user device, the platform 130 may extract textual data pertaining to determined rate quote application or service. As a further example, the platform 130 may scan an image for data specifying the user's driver's license number.

In exemplary embodiments, the service processing platform 130 can determine whether the one or more images include data that correspond to a particular data type among various predetermined data types (e.g., address, policy number, driver's license). These predetermined data types pertain to a particular application, as discussed.

In step 207, the service processing platform 130 forwards the extracting data to one or more subscriber systems 120 for processing. Providing the extracted data to multiple subscriber systems 120 enable a user to have access to multiple options for a desired service, as the one more subscriber systems would likely be competing for the business of the user.

In certain embodiments, after receiving the extracted data, the one or more subscriber systems 120 processes the data forwarded by the service processing platform 130. The processing of the data by the subscriber systems 120 is executed in accordance with the appropriate processes for the relevant service. The processing of the forwarded data results in applying the data to the determined application to result in the insurance services requested by the user. Advantageously, by obtaining the necessary front-end information via the service processing platform 130, the subscriber systems 120 can reduce overhead and improve service for their customers.

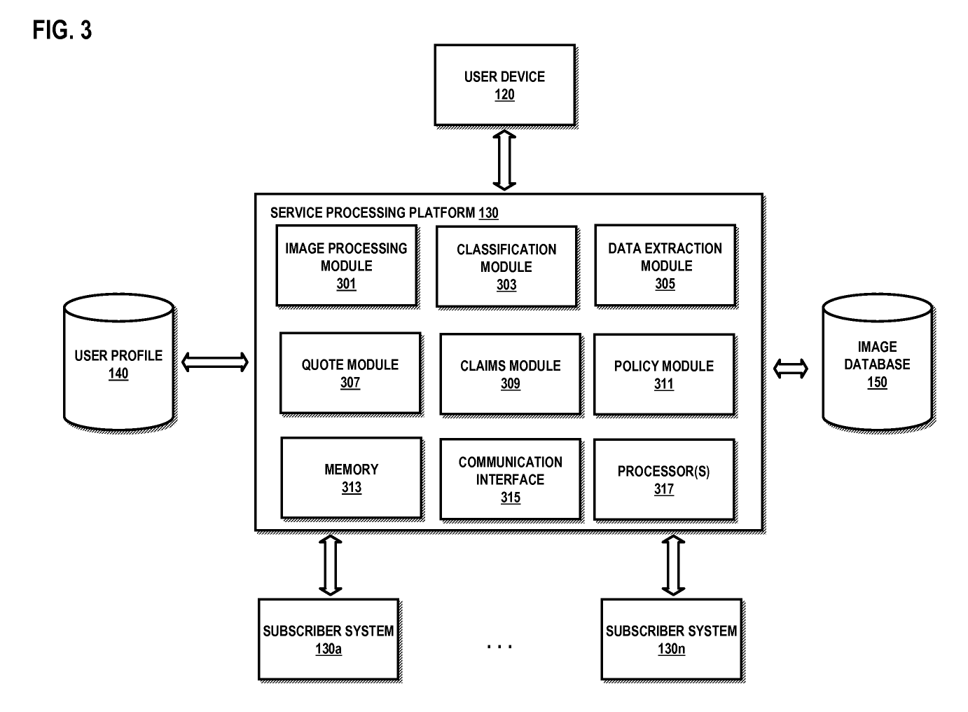

FIG. 3 is a diagram of a service processing platform capable of providing subscriber services, according to one embodiment. Under this example, service processing platform 130 includes various executable modules for performing one or more computing, data processing and network based instructions that in combination enable user device 110 to supply images as a form of conveying needed information for a service. Also, it is noted that the modules encompassing the service processing platform 130 can be implemented in hardware, firmware, software, or a combination thereof. By way of example, the services processing platform may include an image processing module 301, classification module 303, data extraction module 305, quote module 307, claims module 309, policy module 311, memory 313, communication interface 315, processors 317.

The service processing platform 130 maintains communication with user devices 110 and subscriber systems 120. In addition, the service processing platform 130 also maintains one or more repositories or databases for storing data of various types.

By way of example, user profile 140 is a repository that may be maintained for housing data corresponding to user profiles (e.g., users of devices 110). Also, as shown, an image database 150 may be maintained by platform 130 for expressly storing images forwarded from the user device 110. In certain embodiments, the services processing platform 130 may maintain registration data stored within user profile 140 for indicating which users and devices are subscribed to participate in the service management. By way of example, the registration data may indicate profile information regarding the subscribing users and their registered user device(s), profile information regarding affiliated users and user devices, details regarding preferred subscribers and subscriber services, etc., including names, user and device identifiers, account numbers, service classifications, addresses, contact numbers, network preferences and other like information. Registration data may be established at a time of initial registration with the service processing platform 130 and/or subscriber systems 120.

In one embodiment, image processing module 301 processes one or more images and associated request received a user device 110. The image processing module 301 verifies that the quality of the one or more received images is sufficient for use by the service processing platform 130 as to permit processing by the subscriber systems 120. If the service processing platform 130 detects that the images are not of sufficient quality, the platform 130, as noted, may take measures to obtain sufficient quality images. For example, the platform 130 may request to provide additional images. In other embodiments, the image processing module 301 may alter or enhance the received images to satisfy quality requirements of the service processing platform 130.

In certain embodiments, the classification module 303 is configured to intelligently determine an application based on a request from a user of a user device 110. For example, the service processing platform 130 receives one or more images and an associated request for a particular service. The classification module 303 determines the application based on the request, in which the application will be associated with the requested service.

The data extraction module 305 is configured to extract data from one or more images received by the service processing platform 130 from a user device 110. In certain embodiments, the data extraction module 305 extracts textual data from the images received from the user device 110. The data extraction module 305 extracts data according to an application that is determined by the classification module 303. The extraction of text may be performed by recognizing characters embedded in an image and translating the characters into an electronic file. In certain embodiments, the data extraction module 305 recognizes an extracts predetermined text. The predetermined text can be any text and/or information that has been determined as being relevant and/or critical for providing one or more services. This information could be a driver's license, address information, account number, a social security number, etc. For example, the service processing platform 130 receives an image of a driver's license and an associated request for adding a member to an insurance policy. The data extraction module 305 may extract, according to an application determined by the classification module 303, the driver's license number from the image of the driver's license, for use by the subscriber system 120 in processing the request.

In certain embodiments, service processing platform 130 is configured to facilitate insurance services, and thus, may include a quote module 307, claims module 309, and an insurance policy module 311. The quote module 307 is configured to determine and obtain the necessary data needed by one or more of the subscriber systems 120 to provide pricing information for an insurance policy across one or more of the subscriber systems. The claims module 309 is configured to determine and obtain the necessary data needed by one or more of the subscriber systems 120 to provide processing of a claim for the insurance policy.

In one embodiment, one or more processor (or controllers) 317 for effectuating the aforementioned features and functionality of the service processing platform 130, as well as one or more memories 313 for permanent and/or temporary storage of one or more of the aforementioned variables, parameters, information, signals, etc. In this manner, the features and functionalities of subscriber management may be executed by processor 317 and/or memories 313, such as in conjunction with one or more of the various components of service processing platform 130.

In one embodiment, the various protocols, data sharing techniques and the like required for enabling collaboration over the network between user device 110, subscriber systems 120, and the service processing platform 130 is provided by a communication interface 315. As the various devices may feature different communication means, the communication interface 315 allows the service processing platform 130 to adapt to these needs respective to the required protocols of the service provider network 117. In addition, the communication interface 315 may appropriately package data for effective receipt by a respective user device, such as a mobile phone. By way of example, the communication interface 315 may package the various data maintained in the user profile 140 and image database 150 for enabling shared communication and compatibility between different types of devices.

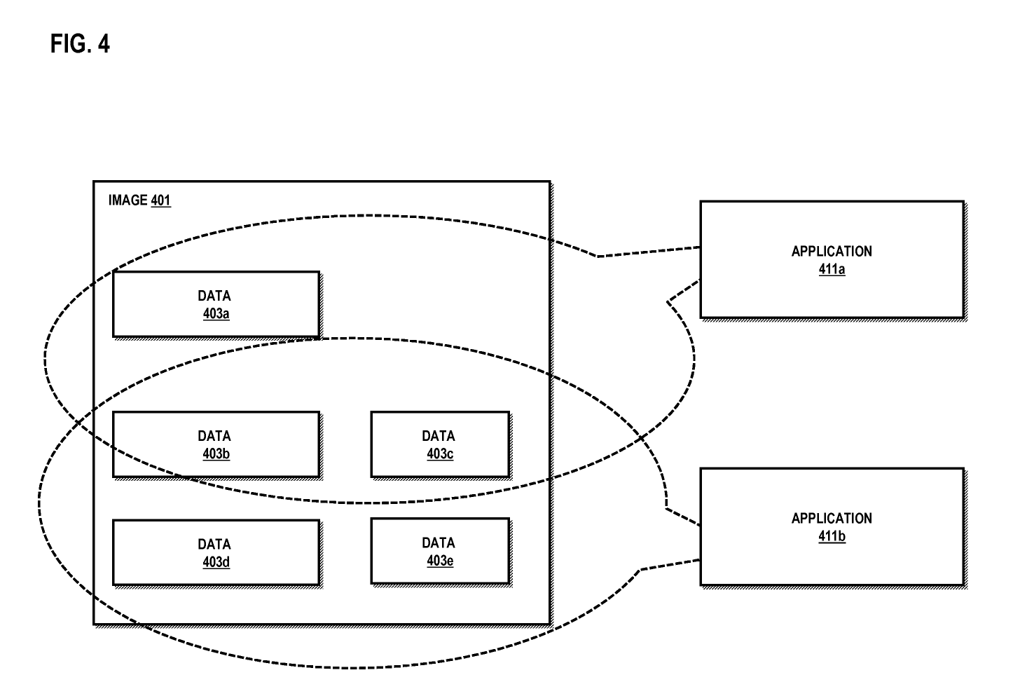

FIG. 4 is a diagram demonstrating extraction of data from an image by multiple applications, according to one embodiment. In certain embodiments, service processing platform 130 may determine one or more applications that are associated with a request of a user device 110. Extraction of textual data from an image 401 may depend on the determined one or more applications. As an example, FIG. 4 depicts two applications 411a and 411b, both of which have different requirements for the data types to be extracted by the service processing platform 130. For instance, application 411a may correspond to obtaining a rate quote, while application 411b is concerned with processing an insurance claim. Because of the different applications, platform 130 may receive the same image but will focus on different areas of the image because of the particular data types required by the respective applications 411a and 411b. Namely, application 411a requires data 403a, 403b, and 403c, while application 411b utilizes data 403b, 403c, 403d, and 403e. As seen, the data can be overlapping.

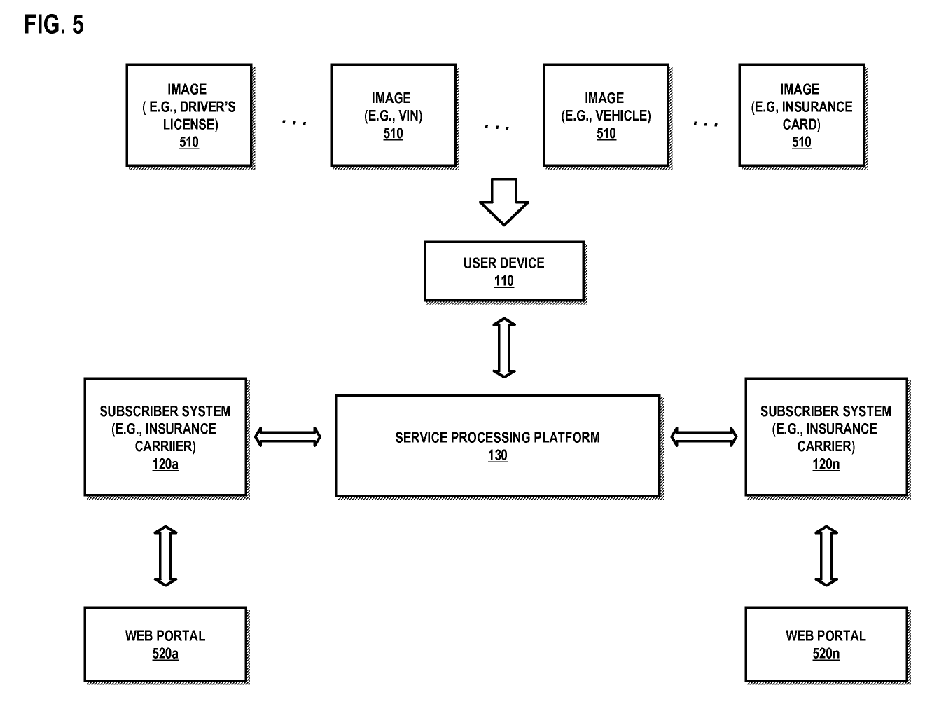

FIG. 5 is a diagram of a system capable of providing subscriber services, according to one embodiment. In certain embodiments, a user of a user device 110 may capture various images to be forwarded to one or more subscriber systems 120 via a service processing platform 130, depending the desired service. For example, if a user were requesting pricing information for insurance across subscriber systems 120a-120n, the user may capture images 510 of the user's driver's license, vehicle identification number, the vehicle, and/or the users' insurance card. As mentioned, which images to be taken and forwarded is dependent on the particular application or service—e.g., obtaining a quote, updating a policy, or initiating a claim (e.g., after an accident). For a rate quote, images of the driver's license and VIN are supplied to platform 130. To update or modify an existing insurance policy, an image of a driver's license of the to-be-added member can be taken along with the image of the current insured's policy card. With respect to an insurance claim, images of the driver's licenses of the insured and the other party can be captured, along with the corresponding VINs; in addition, images of the damages can be uploaded to the platform 130 for the adjuster to examine. Further, the claims application 113 may instruct the user to take images of the environment; e.g., intersection, skid marks, obstructions, etc.

Once the image is captured by the user device 110, the user may trigger the process for forwarding the captured images to the platform 130, which in turn communicates the data extracted from these images to the subscriber systems 120a-120n. As shown, each of the subscriber systems 120a-120n can utilize web portals 520a-520n, respectively for direct access by the user.

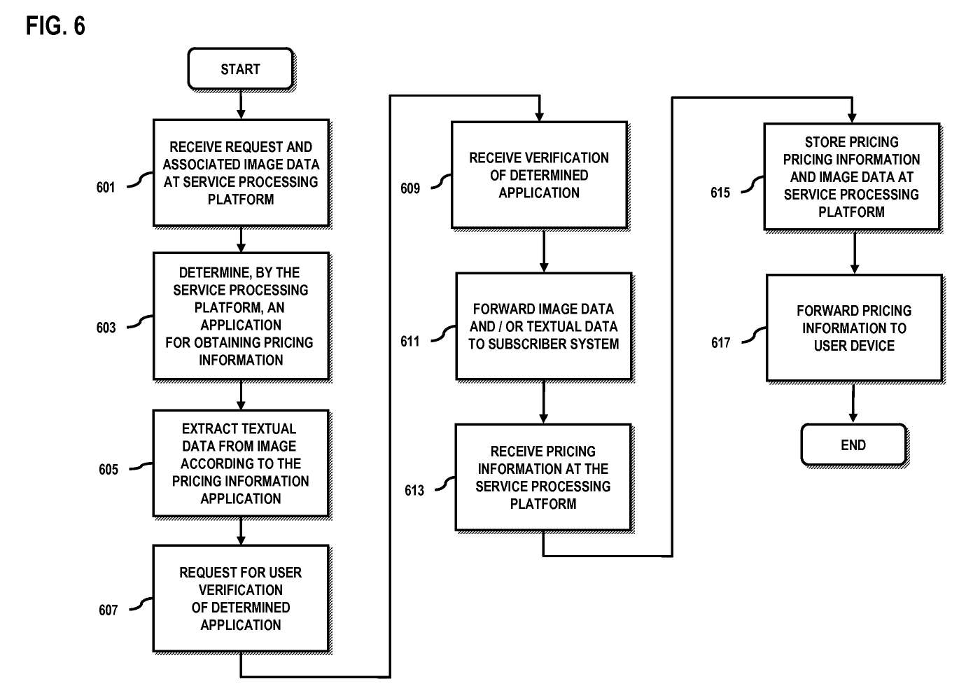

FIG. 6 is a flowchart of a process for obtaining pricing information of insurance services, according to one embodiment. In step 601, service processing platform 130 receives a request and associated image data from a user device 110. For example, a potential new policy holder would like to receive rate quotes for a new vehicle (e.g., sports car). In step 603, service processing platform 130 determines an application for obtaining pricing information is associated with the request. In step 605, the service processing platform 130 extracts textual data from one or more images of the image data.

In step 607, service processing platform 130 requests the user of user device 110 to verify the determined application is the desired application. Requesting verification from the user assists in obtaining all of the correct data so that the vendor of subscriber system 120 has the information needed. In step 609, the service processing platform receives verification that the determined application is the desired application; such verification can be automatic between platform 130 and application 113.

In step 611, the service processing platform 130 forwards image data and/or the extracted textual data to one or more subscriber systems 120. In step 613, the service processing platform 120 receives pricing information at the service processing platform 130.

In step 615, the service processing platform stores the pricing information and the image data. In step 617, the service processing platform 130 forwards the pricing information to the user device 110.

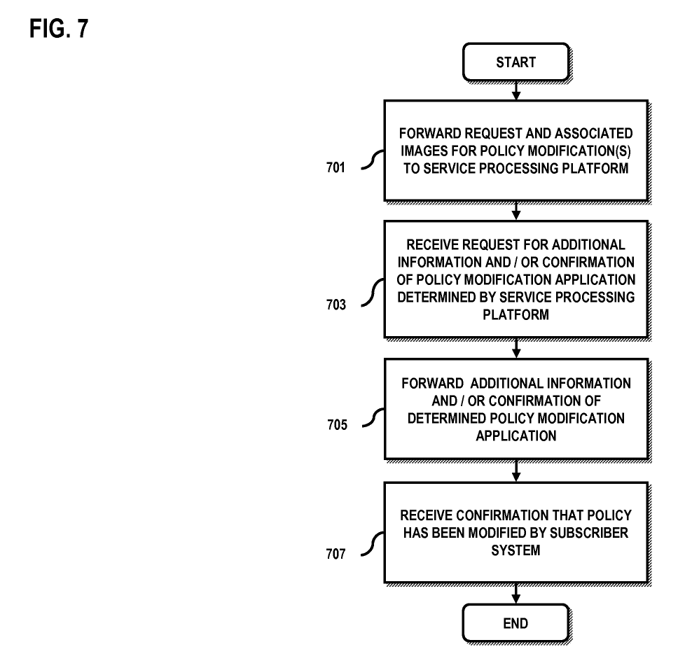

FIG. 7 is a flowchart of a process for requesting modification of an existing policy, according to one embodiment. In step 701, a user of user device 110 forwards a request and associated images for policy modification to a service processing platform 130. In step 703, user device 110 receives a request for additional information and/or confirmation of a determined policy modification application. In step 705, user device forwards additional information and/or confirmation of determined policy modification application. In step 707, user device 110 receives confirmation that policy has been modified by a subscriber system 120.

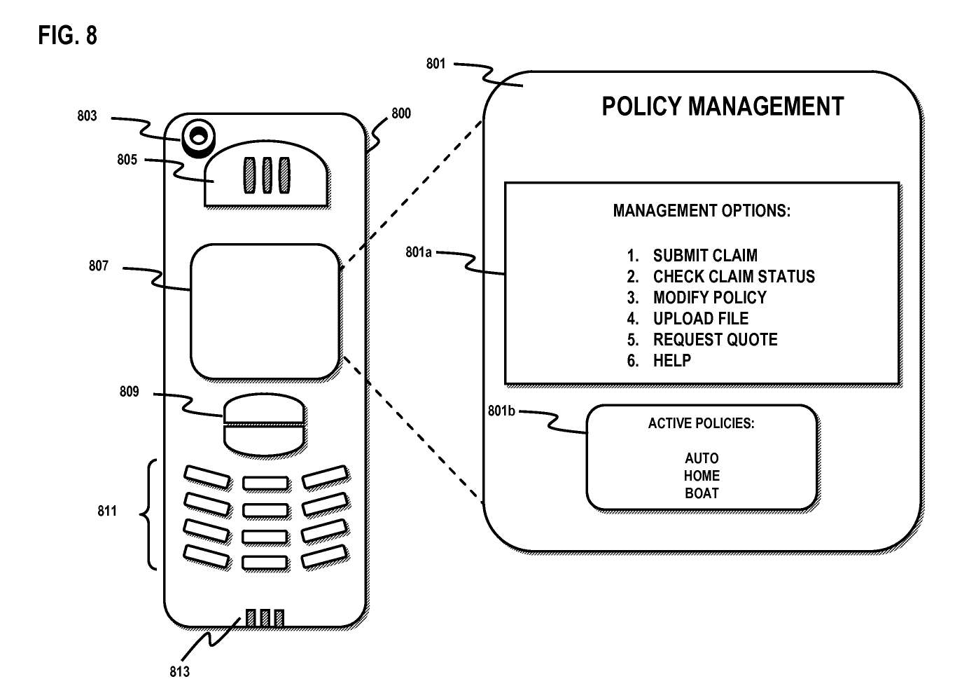

FIG. 8 is a diagram of a mobile device capable of providing a graphical user interface (GUI) configured to present policy management options and active policies, according to one embodiment. In this example, screen 801 includes window 801a that presents multiple managements options: 1) submit claim, 2) check claim status, 3) modify policy, 4) upload file, 5) request quote, and 6) help. It is noted that this request quote option may pertain to new policies that the user may wish to add for the current insurance carrier; as opposed to an application that requests a rate quote across multiple carriers. The window 801b presents a list of all active policies associated with the user; e.g., auto, home, and boat.

As shown, the mobile device 800 (e.g., smart phone) may also comprise a camera 803, speaker 805, screen 807, navigation buttons 809, and keypad 811, and microphone 813.

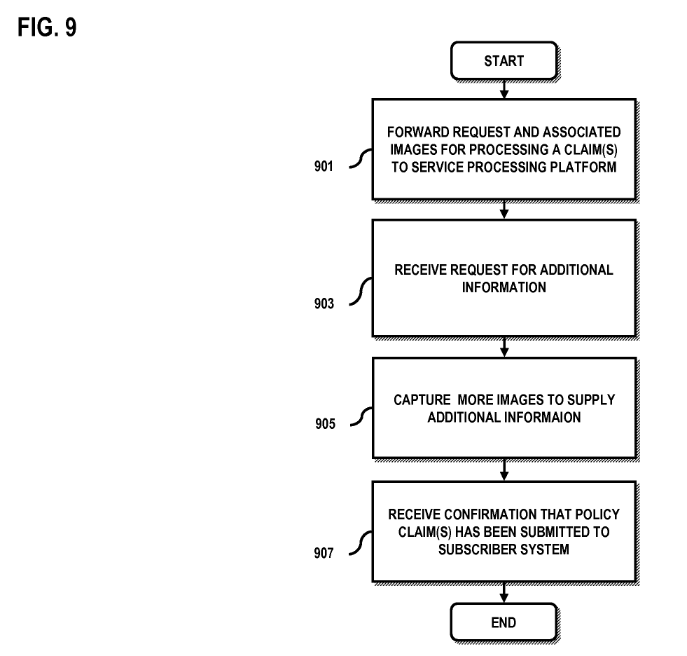

FIG. 9 is a flowchart of a process for requesting processing of a claim according to one embodiment. Under this scenario, a user of user device 110 may invoke application 113 to report a claim, in response to an event (e.g., two car accident). The application 13 may prompt user for images of a driver's license, license plates of both cars involved, to start the process. In step 901, the user device 110 forwards a request and the associated images for policy claim processing to service processing platform 130. In step 903, user device 110 receives a request for additional information to process by the application 113, for example. In step 905, the additional information can be supplied through the taking of additional images by the user. In step 907, receive confirmation that policy claim has been accepted by a subscriber system 120. In certain embodiments, an adjuster of the subscriber system 120 can be assigned to the claim, for example, in real-time based on location information of the user device 110.

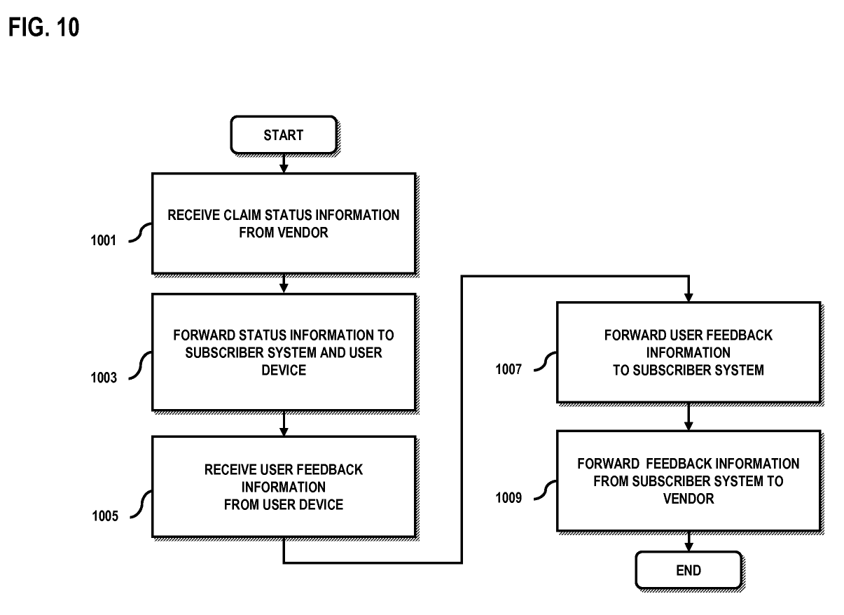

FIG. 10 is a flowchart of a process for obtaining status update on the processing of a claim, according to one embodiment. In step 1001, service processing platform 130, receives claim status information from a vendor (e.g., subscriber system 120a). For example, if a user submitted a claim to have an automobile repaired, the auto repair shop may provide an update as to the services rendered. In certain embodiments, the update by the auto-body shop could be provided as courtesy by the auto repair shop, or the auto-body shop could be prompted to provide the update by service processing platform 130 (assuming the auto body shop is a subscriber to the services of platform 130). In further embodiments, the auto repair shop can provide updates of the status information in real-time. In one embodiment, per step 1003, the service processing platform 1003 forwards status information to the subscriber system 120a and user device 110.

In step 1005, service processing platform 130 receives feedback information from the user device 110. In step 1007, service processing platform 130 forwards user feedback to subscriber system 120a. In step 1009, the service processing platform 130 forwards the feedback information to the appropriate vendor.

The processes described herein for processing images to supply information to various subscriber systems may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

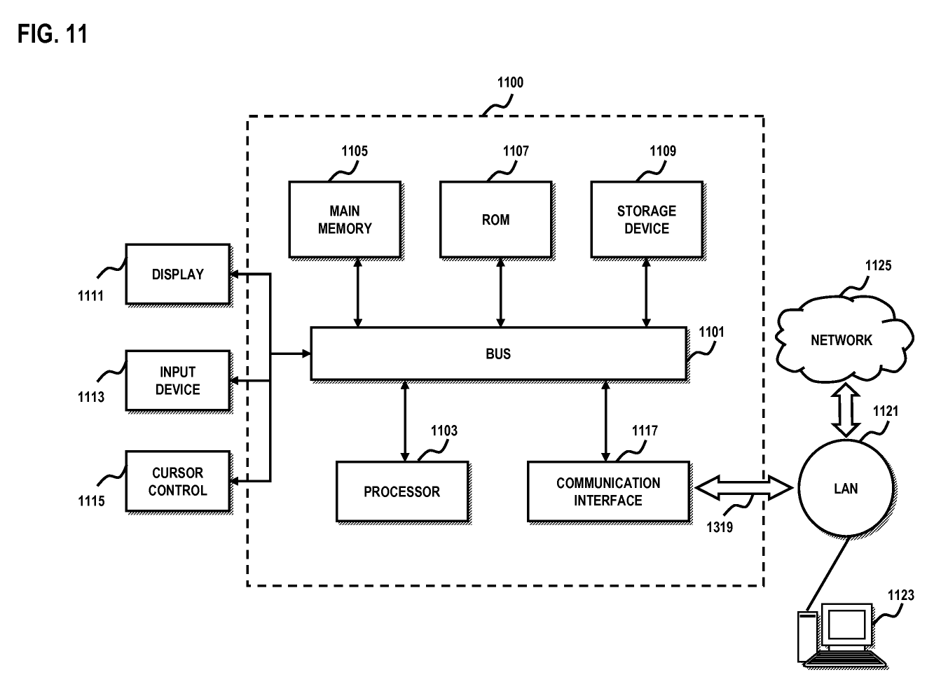

FIG. 11 is a diagram of a computer system that can be used to implement various exemplary embodiments. The computer system 1100 includes a bus 1101 or other communication mechanism for communicating information and one or more processors (of which one is shown) 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for adjusting cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

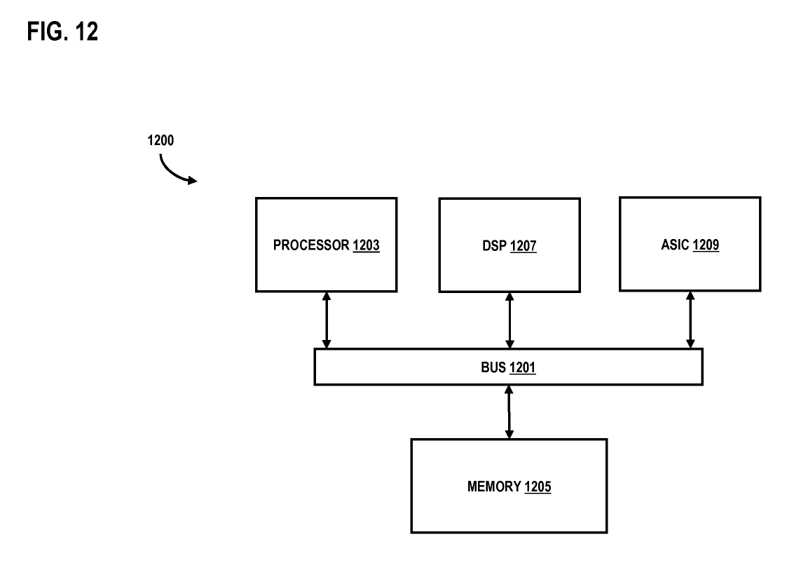

FIG. 12 illustrates a chip set or chip 1200 upon which an embodiment of the invention may be implemented. Chip set 1200 is programmed to configure a mobile device to enable processing of images as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of configuring a mobile device to enable accident detection and notification functionality for use within a vehicle.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to configure a mobile device to enable accident detection and notification functionality for use within a vehicle. The memory 1205 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving, by a service processing platform, one or more images and an associated request;
determining an application associated with the request;
extracting, by the service processing platform, data from the one or more images according to the determined application; and
forwarding, by the service processing platform, the extracted data to one or more subscriber systems for processing based on a subscriber service, wherein the one or more subscriber systems are registered with the service processing platform.

2. The method according to claim 1, wherein the subscriber service includes insurance service, and the data is extracted specifies insurance information.

3. The method according to claim 2, wherein the request relates to either obtaining pricing information for the insurance service across the subscriber systems, updating an existing insurance policy, or processing an insurance claim.

4. The method according to claim 1, further comprising:
determining, by the service processing platform, whether the one or more images include data that corresponds to one of a plurality of predetermined data types, wherein the plurality of predetermined data types are associated with the determined application.

5. The method according to claim 4, wherein the predetermined data includes predetermined textual data.

6. The method according to claim 1, further comprising:
classifying, by the service processing platform, the extracted data into one of a plurality of predetermined classes based on the determined application.

7. The method according to claim 1, further comprising:
receiving, by the service processing platform, one or more reports generated by the one or more subscriber systems based on the extracted data; and
permitting access to the one or more reports by a user device.

8. The method according to claim 1, wherein the one or more image files are received from a user device, and the request includes location information of the user device for determining where the service is needed.

9. The method according to claim 1, wherein the predetermined data includes predetermined textual data.

10. An apparatus comprising:
a processor; and
at least one memory including computer program instructions,
the at least one memory and the computer program instructions configured to, with the processor, cause the apparatus to perform at least the following:
receive a request and associated one or more images,
determine an application associated with the request,
extract data from the one or more images according to the determined application, and
forward the extracted data to one or more subscriber systems for processing based on a subscriber service, wherein the one or more subscriber systems are registered with the apparatus.

11. The apparatus according to claim 10, wherein the subscriber service includes insurance service, and the data is extracted specifies insurance information.

12. The apparatus according to claim 11, wherein the request relates to either obtaining pricing information for the insurance service across the subscriber systems, updating an existing insurance policy, or processing an insurance claim.

13. The apparatus according to claim 10, wherein the apparatus is further caused to:
determine whether the one or more images include data that corresponds to one of a plurality of predetermined data types, wherein the plurality of predetermined data types are associated with the determined application.

14. The apparatus according to claim 13, wherein the predetermined data includes predetermined textual data.

15. The apparatus according to claim 10, wherein the apparatus is further caused to:
classify the extracted data into one of a plurality of predetermined classes based on the determined application.

16. The apparatus according to claim 10, wherein the apparatus is further caused to:
receive one or more reports generated by the one or more subscriber systems based on the extracted data; and
permit access to the one or more reports by a user device.

17. The apparatus according to claim 10, wherein the predetermined data is predetermined textual data.

18. A system comprising:
an image processing module configured to process one or more images received with a request for an application;
a classification module configured to determine an application based on a request;
a data extraction module configured to extract data from the one or more images, the data is extracted according to the determined application; and
a quote module configured to forward the extracted data to one or more subscriber systems for processing based on a subscriber service, wherein the subscriber service includes insurance service.

19. The system according to claim 18, wherein the data is extracted specifies insurance information, and the request relates to either obtaining pricing information for the insurance service across the subscriber systems, updating an existing insurance policy, or processing an insurance claim.

20. The system according to claim 18, wherein the classification module is further configured to determine whether the one or more images include data that corresponds to one of a plurality of predetermined data types, wherein the plurality of predetermined data types are associated with the determined application.

21. The system according to claim 18, wherein the classification module is further configured to classify the extracted data in predetermined classes based on the determined application.
